(19) United States
(12) Patent Application Publication
(10) Pub. No.: US 2025/0128554 A1
(43) Pub. Date: Apr. 24, 2025

(54) TOW HOOK ASSEMBLY

(71) Applicants: HYUNDAI MOTOR COMPANY, Seoul (KR); KIA CORPORATION, Seoul (KR)

(72) Inventor: Eonpyo Kim, Hwaseong-si (KR)

(73) Assignees: HYUNDAI MOTOR COMPANY, Seoul (KR); KIA CORPORATION, Seoul (KR)

(21) Appl. No.: 18/919,088

(22) Filed: Oct. 17, 2024

(30) Foreign Application Priority Data
Oct. 20, 2023 (KR) 10-2023-0140976
Sep. 20, 2024 (KR) 10-2024-0127199

(51) Int. Cl. B60D 1/56; B60D 1/04; B60R 19/02

(52) U.S. Cl. CPC B60D 1/565; B60D 1/04; B60R 19/023

(57) ABSTRACT

A tow hook assembly mounted on a bumper beam disposed in the vehicle width direction. In particular, the tow hook assembly includes a strengthening member connected to the bumper beam, and a tow hook connected to the strengthening member along the front-to-back direction of the vehicle body.

### CROSS-REFERENCE TO RELATED APPLICATION

This application claims priority to and the benefit of Korean Patent Application No. 10-2023-0140976, filed in the Korean Intellectual Property Office on Oct. 20, 2023, and Korean Patent Application No. 10-2024-0127199 filed in the Korean Intellectual Property Office on Sep. 20, 2024, the entire contents of which are incorporated herein by reference.

### BACKGROUND

### (a) Field

The present disclosure relates to a vehicle body. More particularly, the present disclosure relates a tow hook assembly mounted on a bumper beam of a vehicle body.

### (b) Description of the Related Art

In general, a bumper unit for a vehicle is configured to promote the safety of occupants by absorbing the physical impact during a collision and to minimize damage to vehicle body parts. The bumper unit for the vehicle has a bumper beam disposed in the vehicle width direction.

A tow hook can be mounted on these bumper beams. In one example, the tow hook may be provided as an eye bolt type that can engage with a tow pipe fixed to the bumper beam.

In another example, the tow hook may be of the lugged type protruded from the bumper skin of the bumper beam. This lugged type tow hook is being applied to the front of the vehicle to satisfy recently strengthened off-road towing load conditions. Furthermore, a lugged type tow hook may be applied to the front of the vehicle along with a bull bar to protect the front of the vehicle.

In this case, the lugged type tow hook is protruded forward to a certain level to avoid interference with the towing rope and the bull bar.

However, as the distance between the bumper skin of the rigid bumper beam and the front end of the tow hook is excessive, it is difficult to secure the mounting rigidity and towing strength of the tow hook, which makes it difficult to satisfy the enhanced off-road towing load conditions.

The matters described in this background art section are written to improve understanding of the background of the present disclosure, and may include matters that are not conventional art already known to a person of an ordinary skill in the field to which this technology belongs.

### SUMMARY

The present disclosure attempts to provide a tow hook assembly that can secure the mounting strength and towing strength and satisfy enhanced off-road towing load conditions.

In an embodiment of the present disclosure, a tow hook assembly mounted on a bumper beam disposed in the vehicle width direction is provided. In particular, the tow hook assembly may include a strengthening member connected to the bumper beam, and a tow hook connected to the strengthening member along the front-to-back direction of the vehicle body.

The bumper beam and the strengthening member may be provided as a rigidity unit connected to each other.

In an embodiment, a tow hook assembly is mounted on a bumper beam connected to a front of a stay connected to a front side member, and the tow hook assembly may include: a mounting bracket disposed on a front bumper skin of the bumper beam and connected to the bumper beam and the stay, and a tow hook connected to the mounting bracket along the front-to-back direction of the vehicle body.

The mounting bracket may be connected to the front bumper skin of the bumper beam.

The mounting bracket may be connected to an upper flange and a lower flange of the stay, which are connected to a rear bumper skin, an upper surface, and a lower surface of the bumper beam.

The mounting bracket may include a bracket upper side where a first flange is formed at a rear, and a bracket front side extending downward from a front of the bracket upper side. The mounting bracket may further include a bracket lower side that extends rearward from a lower part of the bracket front side and includes a second flange, and bracket side surfaces that respectively extend rearward from both ends of the bracket front side and include a third flange.

Each bracket side surface may include an upper reinforcing portion extending from an upper portion of the bracket side surface in the vehicle width direction, and a lower reinforcing portion extending from a lower portion of the bracket side surface in the vehicle width direction. The upper reinforcing portions of the bracket side surfaces face each other, and the lower reinforcing portions of the bracket side surfaces face each other.

The upper reinforcing portions may be connected to the bracket upper side by welding.

The lower reinforcing portions may be connected to the bracket lower side by welding.

The first flange may overlap the upper flange of the stay that is connected to the rear bumper skin, the upper surface, and the lower surface of the bumper beam, and the first flange may be bolted and connected to the upper surface of the bumper beam.

The first flange may include an up-flange portion bent in an upward direction.

The second flange may include a down-flange portion bent in a downward direction.

The second flange may overlap the lower flange of the stay in the vertical direction and is connected to the lower surface of the bumper beam.

The third flange may overlap the front bumper skin of the bumper beam along the front-to-back direction of the vehicle body, and may be fixedly connected to the front bumper skin of the bumper beam.

The third flange may include at least one forming part protruded in a forward direction.

The tow hook may have a “U” shape and be fixedly connected to the bracket side surfaces.

The tow hook may include a pair of leg portions connected to the bracket side surfaces, and a hook connected to the pair of leg portions;

The hook may be formed slanted at a predetermined angle from a virtual horizontal line along the vehicle width direction.

In one embodiment, one sheet may be folded to form the bracket upper side, the bracket front side, the bracket lower side, and the bracket side surfaces of the mounting bracket.

The mounting bracket may further include a patch member connected to the bracket side surfaces.

The mounting bracket may include a first bracket and a second bracket that are joined to each other. In one form, the bracket side surfaces include a first bracket side surface and a second side surface.

The first bracket may include the bracket upper surface, the bracket front surface, the bracket lower surface, and the first bracket side surface, which are formed by one plate.

The second bracket may include the second bracket side surface formed by one plate.

The mounting bracket may include a lower bracket and an upper bracket that are connected to each other.

The lower bracket may include a bracket front side, a bracket lower side, two lower bracket side surfaces, and an upper flange extending rearwardly from the upper portion of the bracket front side formed by folding predetermined portions of a plate.

The upper bracket may include a bracket upper side and two upper bracket side surfaces formed by folding predetermined portions of another plate.

The lower bracket may further include lower reinforcing portions extending in the vehicle width direction facing each other at the bottom.

The upper flange may be spaced from the bumper beam.

The upper flange and the bracket upper side may be connected by welding.

The lower bracket side surface and the upper bracket side surface may be welded.

According to embodiments of the present disclosure, by securing the towing strength and mounting strength of the tow hook, stable towing performance can be achieved and enhanced off-road towing load conditions can be satisfied.

In addition, various effects that can be obtained or predicted from the present disclosure are disclosed directly or implicitly in the detailed description of the embodiments.

### BRIEF DESCRIPTION OF THE DRAWINGS

Since these drawings are intended for reference in explaining an exemplary disclosure of the present disclosure, the technical idea of the present disclosure should not be interpreted as limited to the accompanying drawings.

FIG. 1 is a perspective view showing a tow hook assembly according to an embodiment.

FIG. 2 is a partial exploded perspective view showing the tow hook assembly according to an embodiment.

FIG. 3 and FIG. 4 are perspective views showing a mounting bracket applied to the tow hook assembly according to an embodiment.

FIG. 5 is a side view showing the mounting bracket applied to the tow hook assembly according to an embodiment.

FIG. 6A is a cross-sectional view showing a connection structure of the mounting bracket applied to the tow hook assembly according to an embodiment.

FIG. 6B is a cross-sectional view showing a connection structure of the mounting bracket and a tow hook applied to the tow hook assembly according to an embodiment.

FIG. 7 is an exploded perspective view showing the connection structure of the mounting bracket and the tow hook applied to the tow hook assembly according to an embodiment.

FIG. 8 is a top plan view showing the connection structure of the mounting bracket and the hook applied to the tow hook assembly according to an embodiment.

FIG. 9A is a drawing to explain the operation of the tow hook assembly according to an embodiment.

FIG. 9B is a drawing is showing a typical tow hook for comparing to the tow hook assembly according to an embodiment of the present disclosure.

FIG. 10 is a drawing showing an exemplary variation of a mounting bracket applied to the tow hook assembly according to an embodiment.

FIG. 11 is a drawing showing another variation of a mounting bracket applied to the tow hook assembly according to an embodiment.

FIG. 12 to FIG. 14 are drawings illustrating the other exemplary variation of a mount bracket applied to the tow hook assembly according to an embodiment.

The drawings referenced above are not necessarily drawn to scale and

should be understood as presenting a rather simplified representation of various features illustrating the basic principles of the present disclosure. The specific design features of the present disclosure, including, for example, specific dimensions, orientation, location, and shape, should be determined in part by the particular intended application and usage environment.

### DETAILED DESCRIPTION

Hereinafter, with reference to the attached drawings, embodiments of the present disclosure are described in detail so that those having ordinary skill in the art can easily implement the present disclosure. As those having ordinary skill in the art would realize, the described embodiments may be modified in various different ways, all without departing from the spirit or scope of the present disclosure.

The terminology used in the present disclosure is for the purpose of describing specific embodiments, and is not intended to limit the present disclosure. As used herein, singular forms are intended to also include plural forms, unless the context clearly indicates otherwise.

The terms ‘comprising’ and/or ‘including’ as used in this specification indicate the presence of specified features, integers, steps, operations, elements and/or components, but at least one other feature, integer, step, operation, element and/or component may be present. It should also be understood that this does not exclude the presence or addition of steps, operations, components, and/or groups thereof.

When a component, device, element, or the like of the present disclosure is described as having a purpose or performing an operation, function, or the like, the component, device, or element should be considered herein as being “configured to” meet that purpose or to perform that operation or function.

As used in this specification, the term ‘and/or’ includes any one or all combinations of at least one associated listed item. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

In the present disclosure, the term ‘coupled’ or ‘connected’ means that components are directly connected to each other by welding, SPR (Self Piercing Rivet), FDS (Flow Drill Screw), structural adhesive, etc. or indirectly connected through at least one intermediary component, and physical relationship between two components.

The terms ‘vehicle’, ‘of a vehicle’ or other similar terms used in this specification are generally used in passenger automobiles, including passenger vehicles, sport utility vehicles (SUVs), buses, trucks, and various commercial vehicles, and also including hybrid vehicles, electric vehicles, hybrid electric vehicles, hydrogen power vehicles and other alternative fuel vehicles (e.g., fuels derived from resources other than petroleum).

Hereinafter, embodiments of the present disclosure are described in detail with reference to the attached drawings.

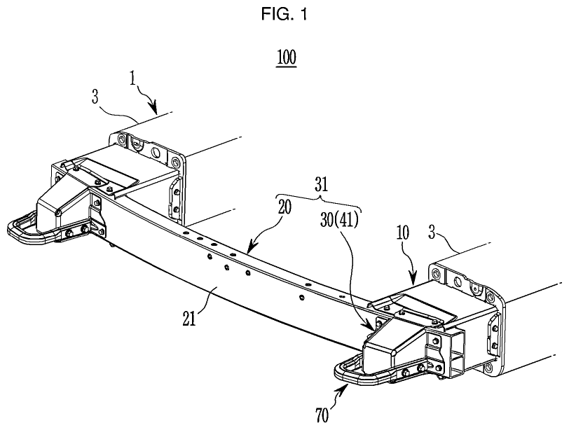

FIG. 1 is a perspective view showing a tow hook assembly according to an embodiment.

Referring to FIG. 1, a tow hook assembly 100 according to an embodiment may be applied to a front vehicle body 1 of a vehicle. The front vehicle body 1 includes front side members 3, stays 10, and a bumper beam 20.

In the present disclosure, the ‘front-to-back direction of the vehicle body’ may be defined as the longitudinal direction of the vehicle body, the ‘vehicle width direction’ may be defined as the left-right direction of the vehicle body, and the ‘up-and-down direction’ (alternatively, “an upward direction” or “a downward direction”) may be defined based on the height direction of the vehicle body.

Furthermore, terms, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in the present disclosure, an end of a component (e.g., one end or another (other) end, etc.) denotes an end of a component in any one direction, and an end portion of the component (e.g., one end portion) or other (another) end portion, etc.) denotes a portion of a component that includes that end.

The front side member 3 is disposed on both sides of the vehicle, and is disposed along the front-to-back direction of the vehicle body. The stay 10 (a person of an ordinary skill in the art is also commonly referred to as a ‘crush box’) is connected to the front end of the front side member 3.

The bumper beam 20 is disposed in the vehicle width direction of front vehicle body 1 and is connected to the stay 10. The bumper beam 20 is bent with a predetermined curvature and can be provided as a beam shape with a closed cross-section. In one example, the bumper beam 20 may be formed from steel material or aluminum material.

The stay 10 is connected to a rear bumper skin 23, an upper surface 25, and a lower surface 27 of the bumper beam 20 through the front part. The stay 10 includes an upper flange 11 and a lower flange 13.

The tow hook assembly 100 according to an embodiment is mounted on the bumper beam 20, which is a rigidity unit, and can be connected to a tow rope (not shown). In an embodiment, the tow hook assembly 100 may be mounted on both sides of the bumper beam 20 along the vehicle width direction.

Furthermore, the tow hook assembly 100 according to an embodiment may be provided as a lugged type protruded from a front bumper skin 21 of the bumper beam 20 to the front.

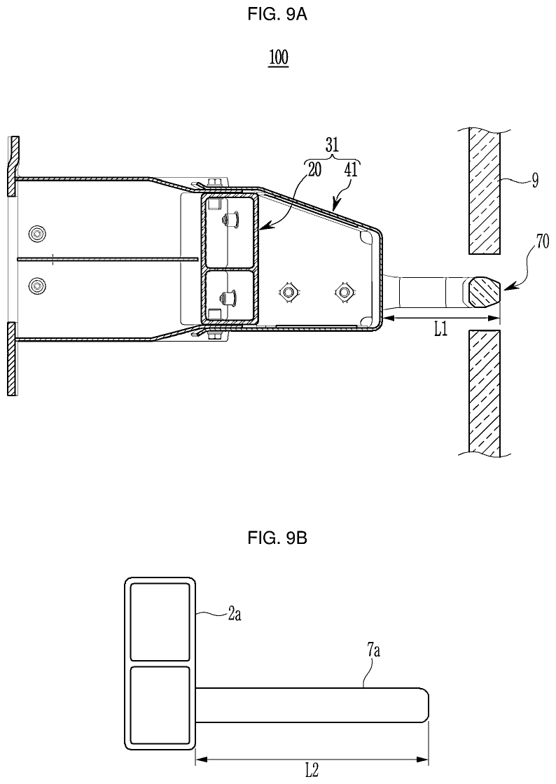

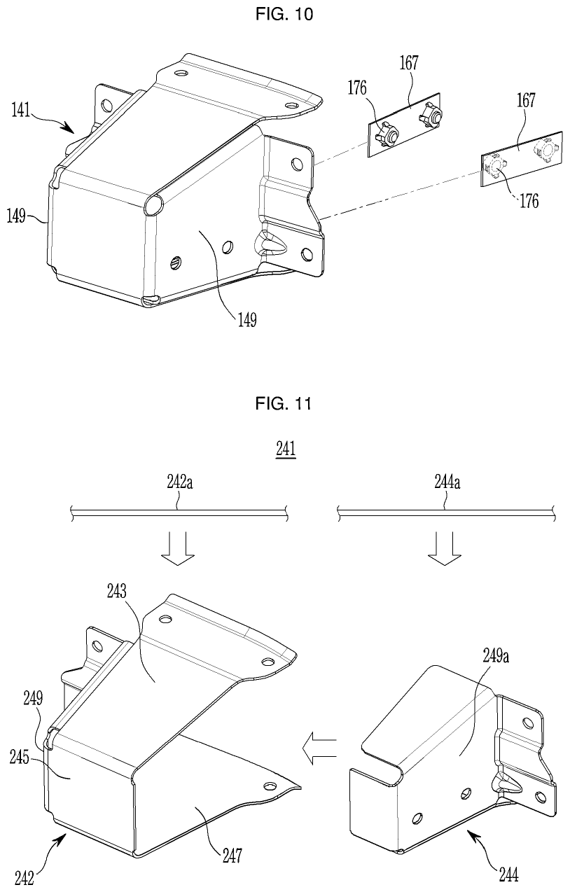

Furthermore, the tow hook assembly 100 according to an embodiment may be configured on the front vehicle body 1 with an applied bull bar 9 (referring to FIG. 9A) to protect the front of the vehicle. Since the configuration of this bull bar is known to those having ordinary skill in the art, detailed description is omitted.

The tow hook assembly 100 may be configured with a structure that can satisfy enhanced off-road tow load conditions while avoiding interference with the tow rope and the bull bar.

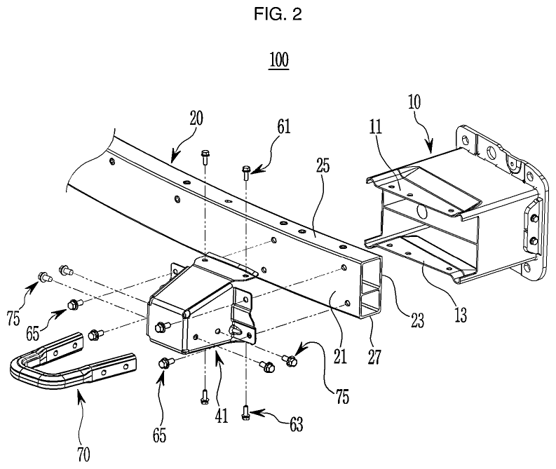

FIG. 2 is a partial exploded perspective view showing the tow hook assembly according to an embodiment.

Referring to FIG. 1 and FIG. 2, the tow hook assembly 100 according to an embodiment includes a strengthening member 30 and a tow hook 70.

In an embodiment, the strengthening member 30 is connected to each side of the bumper beam 20 in the vehicle width direction. In one example, the strengthening member 30 is provided as a bracket type with a predetermined strength, and may be provided as a rigidity unit 31 with the bumper beam 20 connected to each other.

The strengthening member 30 may, in an embodiment, include a mounting bracket 41 connected to the stay 10 and the bumper beam 20.

The mounting bracket 41 has a predetermined shape and is disposed on the front bumper skin 21 of the bumper beam 20. The mounting bracket 41 is connected to the front bumper skin 21 of bumper beam 20 and to the upper flange 11 and the lower flange 13 of the stay 10. In one example, the mounting bracket 41 may be provided in a pentahedral shape with an open rear.

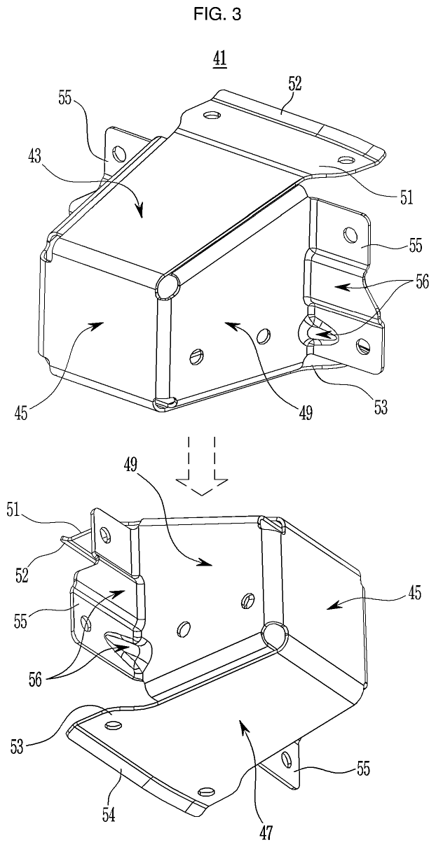

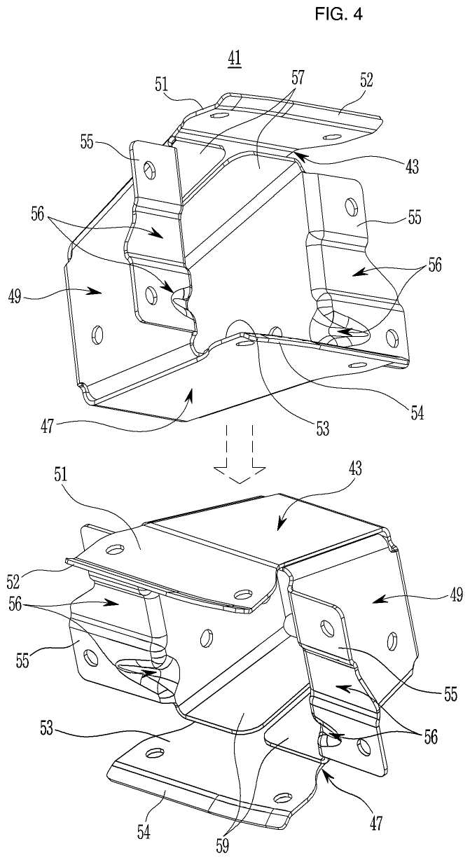

FIG. 3 and FIG. 4 are perspective views showing a mounting bracket applied to the tow hook assembly according to an embodiment, and FIG. 5 is a side view showing the mounting bracket applied to the tow hook assembly according to an embodiment.

Referring to FIG. 1 to FIG. 5, the mounting bracket 41 according to an embodiment includes a bracket upper side 43, a bracket front side 45, a bracket lower side 47, and bracket side surfaces 49.

The bracket upper side 43 includes a first flange 51 formed at a rear. The first flange 51 overlaps with the upper flange 11 of the stay 10 in the vertical direction and is connected by bolting to the upper surface 25 of the bumper beam 20. Furthermore, the first flange 51 includes an up-flange portion 52 bent in an upward direction.

The bracket front side 45 extends downward from a front part of the bracket upper side 43. The bracket upper side 43 is inclined from an upper part to a lower part thereof and is connected to an upper part of the bracket front side 45.

The bracket lower side 47 extends from a lower part of the bracket front side 45 to the rear. The bracket lower side 47 includes a second flange 53 formed at the rear.

The second flange 53 overlaps the lower flange 13 of the stay 10 in the vertical direction and is connected by bolting to the lower surface 27 of the bumper beam 20. The second flange 53 includes a down-flange portion 54 bent in the downward direction.

The bracket side surfaces 49 extend rearward from both ends of the bracket front side 45, respectively. Each of the bracket side surfaces 49 includes a third flange 55 formed at the rear.

The third flange 55 overlaps with the front bumper skin 21 of the bumper beam 20 in the front and rear directions of the vehicle body, and is connected by bolting to the front bumper skin 21 of the bumper beam 20. The third flange 55 includes at least one forming part 56 protruded to the front.

The forming part 56 is configured to reinforce the strength of the mounting bracket 41 for the front bumper skin 21 of the bumper beam 20. The forming part 56 may be provided in the form of a bead convexly molded to the front.

In the mounting bracket 41 according to an embodiment, predetermined portions of one plate 41a are folded to form the bracket upper side 43, the bracket front side 45, the bracket lower side 47, and the bracket side surface 49 as described above.

In other words, by folding one plate 43a to form the mount bracket 41, processing can be simplified and the rigidity of the mount bracket 41 can be secured.

In an embodiment, each of the bracket side surfaces 49 of the mounting bracket 41 further includes an upper reinforcing portion 57 and a lower reinforcing portion 59. The upper reinforcing portions 57 and the lower reinforcing portions 59 are configured to reinforce the strength of the bracket upper side 43, the bracket lower side 47, and the bracket side surfaces 49.

The upper reinforcing portions 57 of the bracket side surfaces 49 extend in the vehicle width direction, facing each other, from the upper part of the bracket side surfaces 49. The upper reinforcing portions 57 overlap the lower surface of the bracket upper side 43. The upper reinforcing portions 57 and the bracket upper side 43 may be connected by welding.

The lower reinforcing portions 59 of the bracket side surfaces 49 extend in the vehicle width direction, facing each other, from the lower part of the bracket side surfaces 49. The lower reinforcing portions 59 overlap the upper surface of the bracket lower side 47. The lower reinforcing portions 59 and the bracket lower side 47 may be connected by welding.

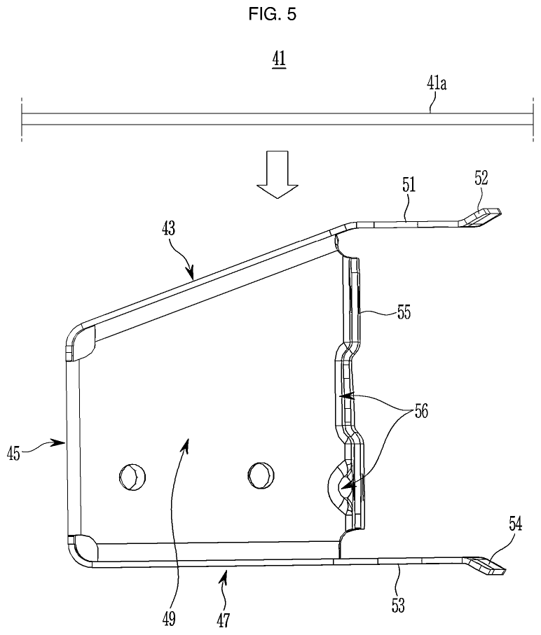

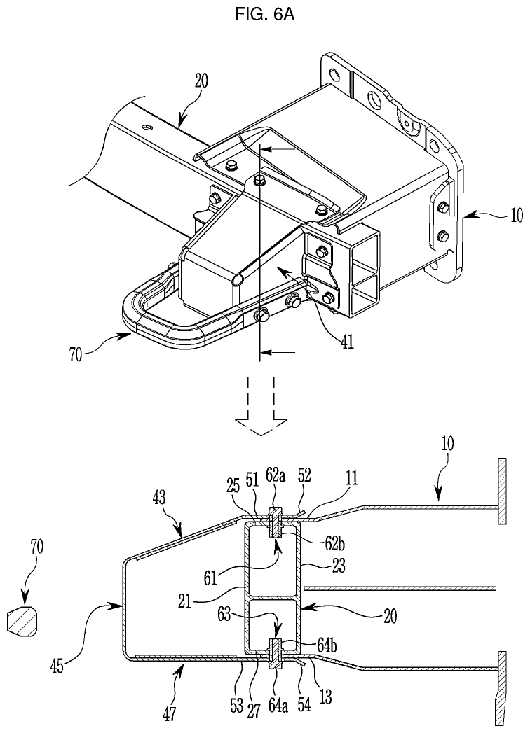

FIG. 6A is a cross-sectional view showing a connection structure of the mounting bracket applied to the tow hook assembly according to an embodiment, and FIG. 6B is a cross-sectional view showing a connection structure of the mounting bracket and a tow hook applied to the tow hook assembly according to an embodiment.

Referring to FIG. 6A and FIG. 6B, in an embodiment, the mounting bracket 41 may be bolted (e.g., overlap engage) to the bumper beam 20 by a first fastening member 61, a second fastening member 63, and a third fastening member 65.

Referring to FIG. 2 and FIG. 6A, the first flange 51 of the bracket upper side 43 of the mounting bracket 41 overlaps the upper flange 11 of the stay 10 in the vertical direction and is bolted to the upper surface 25 of the bumper beam 20 by the first fastening member 61.

The first fastening member 61 includes a first bolt 62a and a first weld nut 62b. The first weld nut 62b is mounted on the upper inner surface of the bumper beam 20. The first bolt 62a penetrates the overlapped first flange 51, the upper flange 11, and the upper surface 25 of the bumper beam 20 and engages with the first weld nut 62b.

The second flange 53 of the bracket lower side 47 of the mounting bracket 41 overlaps the lower flange 13 of the stay 10 in the vertical direction, and is connected to the lower surface 27 of the bumper beam 20 by the second fastening member 63.

The second fastening member 63 includes a second bolt 64a and a second weld nut 64b. The second weld nut 64b is mounted on the lower inner surface of the bumper beam 20. The second bolt 64a penetrates the overlapped second flange 53, the lower flange 13, and the lower surface 27 of the bumper beam 20 and engages with the second weld nut 64b.

Referring to FIG. 2 and FIG. 6B, the third flange 55 of the bracket side surface 49 of the mounting bracket 41 overlaps with the front bumper skin 21 of the bumper beam 20 in the front and rear directions of the vehicle body, and is bolted and connected to the front bumper skin 21 of the bumper beam 20 by the third fastening member 65.

The third fastening member 65 includes a third bolt 66a and a third weld nut 66b. The third weld nut 66b is mounted on the front inner surface of the bumper beam 20. The third bolt 66a penetrates the overlapped third flange 55 and the front bumper skin 21 of the bumper beam 20 and is engaged with the third weld nut 66b.

Referring to FIG. 1 and FIG. 2, in an embodiment, the tow hook 70 is connected to a towing rope (not shown) and to the mounting bracket 41 as strengthening member 30 along the front-to-back direction of the vehicle body.

The tow hook 70 protrudes from the mounting bracket 41 to the front side. The tow hook 70 is connected by bolting to the bracket side surfaces 49 of the mounting bracket 41. In one example, the tow hook 70 may be provided in a ‘U’ shape.

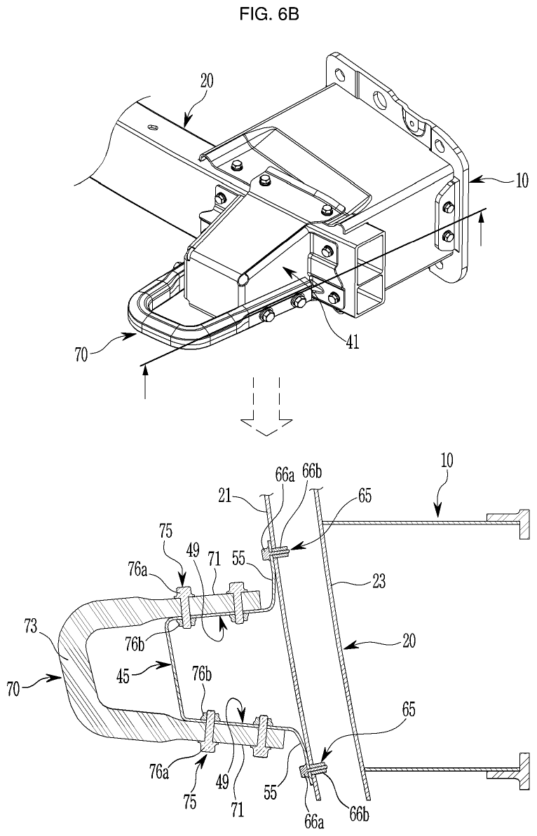

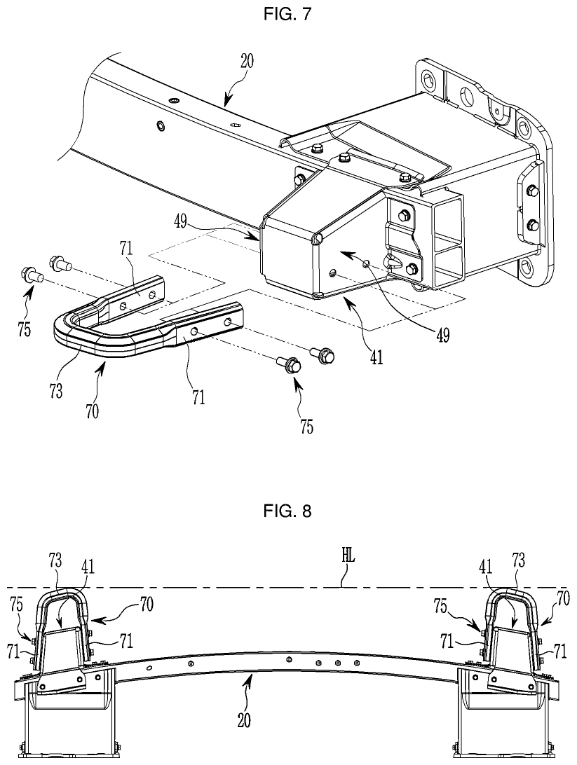

FIG. 7 is an exploded perspective view showing the connection structure of the mounting bracket and the tow hook applied to the tow hook assembly according to an embodiment, and FIG. 8 is a top plan view showing the connection structure of the mounting bracket and the hook applied to the tow hook assembly according to an embodiment.

Referring to FIG. 7 and FIG. 8, the tow hook 70 according to an embodiment includes a pair of leg portions 71 and a hook 73.

The pair of leg portions 71 are connected by bolting to the bracket side surfaces 49 of the mounting bracket 41. The hook 73 is connected to the leg portions 71 along the vehicle width direction.

The hook 73 is connected to the towing rope. In one example, the hook 73 is formed to be inclined at a predetermined angle from a virtual horizontal line HL along the vehicle width direction. In other words, the hook 73 is obliquely connected to the leg portions 71 along the curved line of the bumper beam 20.

The leg portions 71 of the tow hook 70 are in close contact with the bracket side surface 49 of the mounting bracket 41 and may be bolted to the bracket side surface 49 by a fourth fastening member 75.

Referring to FIG. 6B, the fourth fastening member 75 includes a fourth bolt 76a and a fourth weld nut 76b. The fourth weld nut 76b is mounted on the inner surface of the bracket side surface 49. The fourth bolt 76a penetrates the leg portions 71 and the bracket side surface 49 and is engaged with the fourth weld nut 76b.

FIG. 9A is a drawing to explain to explain the operation of the tow hook assembly according to an embodiment.

Referring to FIG. 1 to FIG. 9A, the assembly process and operation of the tow hook assembly 100 according to an embodiment is described in detail below.

The mounting bracket 41 of the predetermined shape is provided. The mounting bracket 41 includes the bracket upper side 43, the bracket front side 45, the bracket lower side 47, and the bracket side surfaces 49 where predetermined portions of one plate 41a are folded.

The bracket side surface 49 includes the upper reinforcing portion 57 and the lower reinforcing portion 59. The upper reinforcing portion 57 is connected to the bracket upper side 43 by welding, and the lower reinforcing portion 59 is connected to the bracket lower side 47 by welding.

The ‘U’ shaped tow hook 70 including the pair of leg portions 71 and the hook 73 is provided.

The bumper beam 20 is connected to the front of front side member 3 through the stay 10. The bumper beam 20 is provided between the upper flange 11 and the lower flange 13 of the stay 10, and the rear bumper skin 23 of the bumper beam 20 is connected to the stay 10 by welding. The upper flange 11 of the stay 10 is connected to the upper surface 25 of the bumper beam 20 by welding, and the lower flange 13 of the stay 10 is connected to the lower surface 27 of the bumper beam 20 by welding.

In this state, the mounting bracket 41 is positioned between the leg portions 71 of the tow hook 70. The leg portions 71 are in close contact with the bracket side surface 49 of the mounting bracket 41.

The fourth bolt 76a penetrates the leg portions 71 and the bracket side surface 49 and engages the fourth weld nut 76b.

The mounting bracket 41 is connected to the upper flange 11 and the lower flange 13 of the stay 10 through the first flange 51 of the bracket upper side 43 and the second flange 53 of the bracket lower side 47.

The third flange 55 of the bracket side surface 49 is in close contact with the front bumper skin 21 of the bumper beam 20. The first flange 51 and the second flange 53 overlap, in the vertical direction, with the upper flange 11 and the lower flange 13 of the stay 10, respectively, with the bumper beam 20 in between.

Because the up-flange portion 52 is formed on the first flange 51 and the down-flange portion 54 is formed on the second flange 53, the mounting bracket 41 can be connected to the stay 10 without interfering with the upper flange 11 and the lower flange 13 of the stay 10.

The first bolt 62a penetrates the overlapped first flange 51, the upper flange 11, and the upper surface 25 of the bumper beam 20 and engages with the first weld nut 62b. The second bolt 64a penetrates the overlapped second flange 53, the lower flange 13, and the lower surface 27 of the bumper beam 20 and engages with the second weld nut 64b. Additionally, the third bolt 66a penetrates the overlapped third flange 55 and the front bumper skin 21 of the bumper beam 20 and engages the third weld nut 66b.

The bumper beam 20 and the mounting bracket 41 connected to the bumper beam 20 may be provided as the rigidity unit 31 with a predetermined strength.

The tow hook assembly 100 according to an exemplary embodiment is mounted on the front bumper skin 21 of the bumper beam 20 and the stay 10 on both sides of the vehicle width direction of the bumper beam 20.

According to the tow hook assembly 100, the mounting bracket 41, which is provided as the rigidity unit 31 together with the bumper beam 20, is disposed between the bumper beam 20 and the tow hook 70. And, the tow hook 70 is mounted protrude to the front on the mounting bracket 41.

FIG. 9B is a drawing is showing a typical tow hook assembly for comparing to the tow hook assembly according to an embodiment of the present disclosure.

As shown in FIG. 9B, according to a typical tow hook, a front end of a tow hook 7a is mounted to be protruded in front from a front bumper skin of bumper beam 2a with a predetermined distance L2 from the front bumper skin of bumper beam 2a.

As shown in FIG. 9A, the tow hook assembly 100 according to an embodiment can reduce the distance L1 from the rigidity unit 31 to the front end of the tow hook 70.

As described above, the tow hook assembly 100 according to an embodiment can reduce the distance from the rigidity unit 31 to the front end of the tow hook 70 compared to typical tow hook of the comparative example, so when towing, the moment applied to the tow hook 70 can be reduced, thereby securing the towing strength of the tow hook 70.

In addition, the tow hook assembly 100 according to an embodiment can secure the mounting strength of the tow hook 70 by mounting the tow hook 70 on the bumper beam 20 through the mounting bracket 41.

Therefore, the tow hook assembly 100 according to an embodiment can secure the towing strength and mounting strength of the tow hook 70, and thus can satisfy the enhanced off-road towing load condition.

And, according to the tow hook assembly 100 according to an embodiment, as the tow hook 70 is protruded to the front above a certain level by the mounting bracket 41, interference between the tow rope (not shown) and the bull bar 9 can be avoided.

When the tow hook assembly 100 according to an embodiment is towed, vertical drag is generated on the bumper beam 20 and the mounting bracket 41 by the first bolt 62a, the first weld nut 62b, the second bolt 64a and second weld nut 64b.

Furthermore, in the tow hook assembly 100 according to an embodiment, shear force is generated on the bumper beam 20 and the mounting bracket 41 by the third bolt 66a and the third weld nut 66b when towing.

Therefore, the tow hook assembly 100 according to an embodiment can secure stable towing performance because vertical drag and shear force act as a support load for the mounting bracket 41 during towing.

Meanwhile, the bracket side surface 49 of the mounting bracket 41 includes the upper reinforcing portion 57 and the lower reinforcing portion 59, and at least one forming part 56 formed on the third flange 55.

Therefore, the tow hook assembly 100 according to an embodiment can increase the strength and vehicle collision performance of the mounting bracket 41 along the front-back direction of the vehicle body, the vehicle width direction, and the vertical direction.

In addition, the bracket upper side 43 of the mounting bracket 41 is inclined from the upper part to the lower part and has a structure connected to the upper part of the bracket front side 45.

As a result, the tow hook assembly 100 according to an embodiment can compactly implement the shape of the mounting bracket 41 and is advantageous in securing the strength of the front part of the mounting bracket 41.

Furthermore, the hook 73 of the tow hook 70 is obliquely connected to the leg portions 71 along the curved line of the bumper beam 20.

Therefore, the tow hook assembly 100 according to an embodiment can further improve the collision performance of the vehicle by increasing the behavior of the tow hook 70 in the vehicle width direction during a small overlap collision of the vehicle.

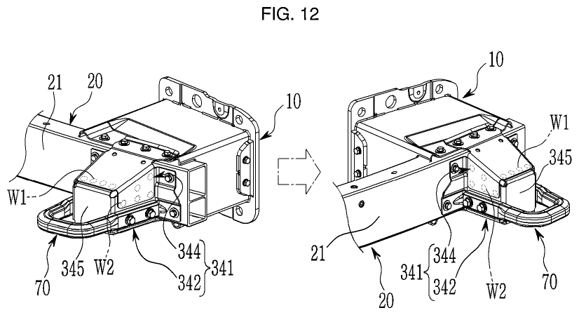

FIG. 10 is a drawing showing a variation of a mounting bracket applied to the tow hook assembly according to an embodiment.

Referring to FIG. 10, an exemplary variation of a mounting bracket 141 according to an embodiment may further include a patch member 167 connected to a bracket side surface 149.

The patch member 167 is provided in a plate shape and can be joined to the inner surface of the bracket side surface 149 by welding. A weld nut 176 may be mounted on the patch member 167 to mount the tow hook (not shown) to the mounting bracket 141.

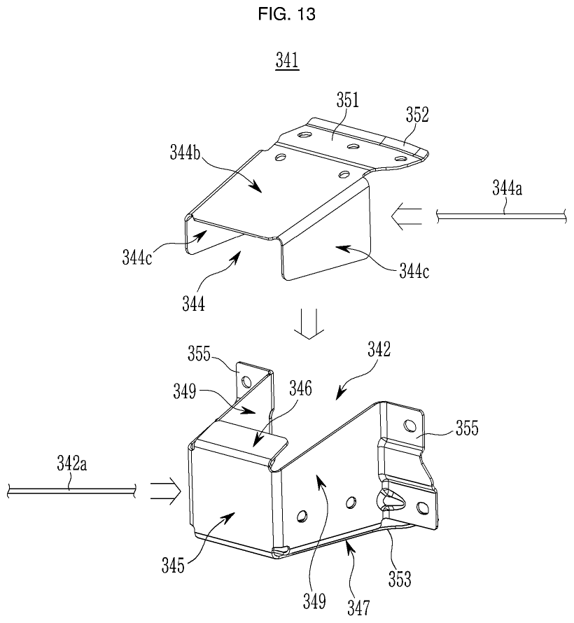

FIG. 11 is a drawing showing another variation of a mounting bracket applied to the tow hook assembly according to an embodiment.

Referring to FIG. 11, another variation of a mounting bracket 241 may include a first bracket 242 and a second bracket 244 connected with each other.

The first bracket 242 may include a bracket upper side 243, a bracket front side 245, a bracket lower side 247, and a bracket side surface 249 in which predetermined portions of one plate 242a are folded.

In addition, the second bracket 244 may include a bracket side surface 249a on the other side where predetermined portions of the other plate 244a are folded.

The first bracket 242 and the second bracket 244 may be connected by welding.

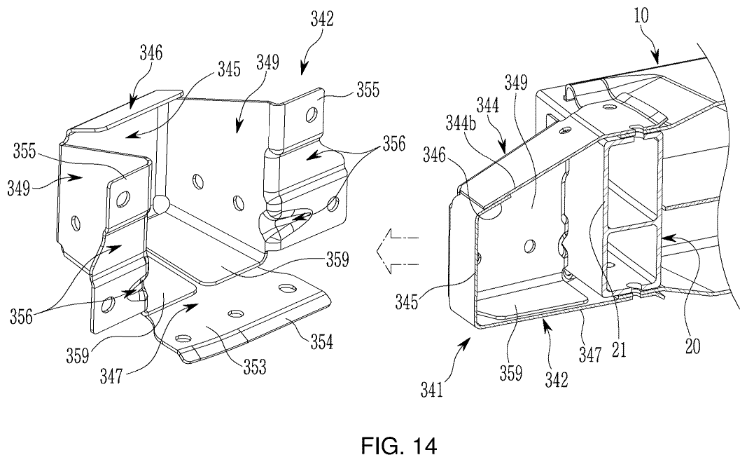

FIG. 12 to FIG. 14 are drawings illustrating the other exemplary variation of a mount bracket applied to the tow hook assembly according to an embodiment.

In describing the other exemplary variation of the mount bracket applied to the tow hook assembly according to an embodiment of FIG. 12 to FIG. 14, a repeated description of the same or similar configuration as the mount bracket applied to the tow hook assembly according to the embodiments described above is omitted.

Referring to FIG. 12 to FIG. 14, a mount bracket 341 according to the other embodiment may include a lower bracket 342 and an upper bracket 344 that are connected to each other.

The lower bracket 342 includes a bracket front side 345, an upper flange 346, a bracket lower side 347, and two lower bracket side surfaces 349 formed by folding predetermined portions of a plate 342a.

The bracket front side 345 is formed at the front portion of the lower bracket 342, and the upper flange 346 extends rearward from the upper portion of the bracket front side 345.

The bracket lower side 347 extends rearwardly from the lower portion of the bracket front side 345, and the lower bracket side surfaces 349 on both sides extend rearwardly from each end in the vehicle width direction of the bracket front side 345.

The upper flange 346 is formed to be spaced apart from the front bumper skin 21 of the bumper beam 20 by a predetermined gap. The two lower bracket side surfaces 349 may include lower reinforcing portions 359 extending in the vehicle width direction facing each other at the bottom. The lower reinforcing portions 359 may be connected to the upper surface of the bracket lower side 347 by welding.

The upper bracket 344 is disposed on upper portion of the lower bracket 342 and may be connected to the lower bracket 342 by welding.

The upper bracket 344 includes a bracket upper side 344b and two upper bracket side surfaces 344c formed by folding predetermined portions of another plate 344a.

The bracket upper side 344b is formed on the upper part of the upper bracket 344, and the upper bracket side surfaces 344c on both sides extend downward from both ends of the bracket upper side 344b in the vehicle width direction.

The bracket upper side 344b of the upper bracket 344 may be connected to the upper flange 346 of the lower bracket 342 by welding, with the upper flange 346 placed on the lower side. That is, the bracket upper side 344b and the upper flange 346 may be connected by the welding portions W1 (see FIG. 12).

And, the upper bracket side surface 344c on both sides of the upper bracket 344 may be connected to the lower bracket side surface 349 on both sides of the lower bracket 342 by welding, with the lower bracket side surface 349 on both sides placed inside. That is, the lower bracket side surface 349 and the upper bracket side surface 344c may be connected by welding portions W2 (see FIG. 12).

Meanwhile, the bracket upper side 344b of the upper bracket 344 is bolted to the upper surface of the stay 10 via a lower flange 351.

The bracket lower side 347 of the lower bracket 342 is bolted to the lower face of the stay 10 via a second flange 353.

And, the lower bracket side surfaces 349 on both sides of the lower bracket 342 are bolted to the front bumper skin 21 of the bumper beam 20 via a third flange 355.

The tow hook 70 according to an embodiment is bolted to the lower bracket side surfaces 349 on both sides of the lower bracket 342.

In the drawing, reference numeral 352 represents an up-flange portion extending from the first flange 351 of the bracket upper side 344b, and reference numeral 354 represents a down-flange portion extending from the second flange 353 of the bracket lower side 347. And, reference numeral 356 indicates forming parts formed on the third flange 355 of the lower bracket side surface 349 on both sides.

Since the configuration and function of the up-flange portion 352, the down-flange portion 354, and the forming parts 356 have been mentioned above, a detailed description will be omitted.

According to the mounting bracket 341 configured as described above, the structure can be provided in which the upper flange 346 of the lower bracket 342 and the bracket upper side 344b of the upper bracket 344 are joined by welding.

According to the mounting bracket 341, the structure may be provided in which both lower bracket side surfaces 349 of the lower bracket 342 and both upper bracket side surfaces 344c of the upper bracket 344 are joined by welding.

Accordingly, since no welding impression is formed on the bracket front side 345 of the lower bracket 342 exposed to the outside, the appearance quality of the vehicle can be improved.

While embodiments of this present disclosure have been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

<Description of symbols>

| | |
|---|---|
| 1: front vehicle body | 3: front side member |
| 10: stay | 11: upper flange |
| 13: lower flange | 20: bumper beam |
| 21: front bumper skin | 23: rear bumper skin |
| 25: upper surface | 27: lower surface |
| 30: strengthening member | 31: rigidity unit |
| 41, 141, 241, 341: mounting bracket | 41a, 242a, 244a, 342a, 344a: plate |
| 43, 243, 344b: bracket upper side | 45, 245, 345: bracket front side |
| 47, 247, 347: bracket lower side | |
| 49, 149, 249, 249a: bracket side | |
| surface | |
| 51, 351: first flange | 52, 352: up-flange portion |
| 53, 353: second flange | 54, 354: down-flange portion |
| 55, 355: third flange | 56, 356: forming part |
| 57: upper reinforcing portion | 59, 359: lower reinforcing portion |
| 61: first fastening member | 62a: first bolt |
| 62b: first weld nut | 63: second fastening member |
| 64a: second bolt | 64b: second weld nut |
| 65: third fastening member | 66a: third bolt |
| 66b: third weld nut | 70: tow hook |
| 71: leg portion | 73: hook |
| 75: fourth fastening member | 76a: fourth bolt |
| 76b: fourth weld nut | HL: horizontal line |
| 100: tow hook assembly | 167: patch member |
| 176: weld nut | 242: first bracket |
| 244: second bracket | |
| 342: lower bracket | |
| 344: upper bracket | |
| 344c: upper bracket side surface | |
| 346: upper flange | |
| 349: lower bracket side surface | |
| W1, W2: welding portion | |

What is claimed is:

1. A tow hook assembly mounted on a bumper beam disposed in a vehicle width direction, the tow hook assembly comprising:
a strengthening member connected to the bumper beam; and
a tow hook connected to the strengthening member along a front-to-back direction of a vehicle body.

2. The tow hook assembly of claim 1, wherein the bumper beam and the strengthening member are provided as a rigidity unit connected to each other.

3. A tow hook assembly mounted on a bumper beam connected to a front of a stay connected to a front side member, the tow hook assembly comprising:
a mounting bracket disposed on a front bumper skin of the bumper beam and connected to the bumper beam and the stay; and
a tow hook connected to the mounting bracket along a front-to-back direction of a vehicle body.

4. The tow hook assembly of claim 3, wherein the mounting bracket is connected to the front bumper skin of the bumper beam, and
wherein the mounting bracket is connected to an upper flange and a lower flange of the stay, which are connected to a rear bumper skin, an upper surface, and a lower surface of the bumper beam.

5. The tow hook assembly of claim 3, wherein the mounting bracket comprises:
a bracket upper side where a first flange is formed at a rear;
a bracket front side extending downward from a front of the bracket upper side;
a bracket lower side extending rearward from a lower part of the bracket front side and including a second flange; and
bracket side surfaces that respectively extend rearward from both ends of the bracket front side and include a third flange.

6. The tow hook assembly of claim 5, wherein each of the bracket side surfaces comprises:
an upper reinforcing portion extending from an upper portion of the bracket side surface in a vehicle width direction; and,
a lower reinforcing portion extending from a lower portion of the bracket side surface in the vehicle width direction,
wherein the upper reinforcing portions of the bracket side surfaces face each other, and the lower reinforcing portions of the bracket side surfaces face each other.

7. The tow hook assembly of claim 6, wherein:
the upper reinforcing portions are connected to the bracket upper side by welding; and
the lower reinforcing portions are connected to the bracket lower side by welding.

8. The tow hook assembly of claim 5, wherein
the first flange overlaps an upper flange of the stay that is connected to a rear bumper skin, an upper surface, and a lower surface of the bumper beam, and
wherein the first flange is bolted and connected to the upper surface of the bumper beam.

9. The tow hook assembly of claim 5, wherein the first flange comprises an up-flange portion bent in an upward direction; and
the second flange comprises a down-flange portion bent in a downward direction.

10. The tow hook assembly of claim 8, wherein the second flange overlaps the lower flange of the stay in a vertical direction and is connected to the lower surface of the bumper beam.

11. The tow hook assembly of claim 10, wherein the third flange overlaps the front bumper skin of the bumper beam along the front-to-back direction of the vehicle body and is fixedly connected to the front bumper skin of the bumper beam.

12. The tow hook assembly of claim 5, wherein the third flange comprises at least one forming part protruded in a forward direction.

13. The tow hook assembly of claim 5, wherein the tow hook has a “U” shape and is fixedly connected to the bracket side surfaces.

14. The tow hook assembly of claim 5, wherein the tow hook comprises:
a pair of leg portions connected to the bracket side surfaces; and
a hook connected to the pair of leg portions.

15. The tow hook assembly of claim 14, wherein the hook is formed slanted at a predetermined angle from a virtual horizontal line along a vehicle width direction.

16. The tow hook assembly of claim 5, wherein one sheet forms the bracket upper side, the bracket front side, the bracket lower side, and the bracket side surfaces of the mounting bracket; and
the mounting bracket further comprises a patch member connected to the bracket side surfaces.

17. The tow hook assembly of claim 3, wherein the mounting bracket includes:
a first bracket and a second bracket that are joined to each other; and
bracket side surfaces including a first bracket side surface and a second side surface,
wherein the first bracket includes a bracket upper surface, a bracket front surface, a bracket lower surface, and a first bracket side surface, which are formed by one plate, and
wherein the second bracket includes a second bracket side surface.

18. The tow hook assembly of claim 3, wherein:
the mounting bracket includes a lower bracket and an upper bracket that are connected to each other,
the lower bracket includes a bracket front side, a bracket lower side, two lower bracket side surfaces, and an upper flange extending rearwardly from an upper portion of the bracket front side formed by folding predetermined portions of a plate, and
the upper bracket includes a bracket upper side and two upper bracket side surfaces formed by folding predetermined portions of another plate.

19. The tow hook assembly of claim 18, wherein the lower bracket further comprises lower reinforcing portions, extending in a vehicle width direction, facing each other.

20. The tow hook assembly of claim 18, wherein:
the upper flange is spaced from the bumper beam;
the upper flange and the bracket upper side are connected by welding; and
the lower bracket side surface and the upper bracket side surface are welded.
